(19) United States
(12) Patent Application Publication
(10) Pub. No.: US 2018/0316962 A1
(43) Pub. Date: Nov. 1, 2018

(54) Methods and Systems for Effective Scrub Bar Navigation

(71) Applicant: SLING MEDIA PVT LTD, BANGALORE (IN)

(72) Inventor: Sriram Prakash, Bangalore (IN)

(21) Appl. No.: 15/499,579

(22) Filed: Apr. 27, 2017

(51) Int. Cl. H04N 21/431; H04N 21/472; H04N 21/44; H04N 21/6587; G06F 3/0485

(52) U.S. Cl. CPC H04N 21/4312; H04N 21/47217; G06F 3/0482; H04N 21/6587; G06F 3/04855; H04N 21/44

(57) ABSTRACT

Various arrangements are presented for managing video content navigation Metadata may be acquired that designates one or more portions of a programming content item as mapped to a predefined category selected from a plurality of predefined categories. A scrub bar interface may be output for presentation that graphically indicates a start point of the programming content, an end point of the programming content, and a scrub bar spanning from the start point to the end point. One or more graphical indications may be output that are indicative of the predefined category on the scrub bar based on the metadata.

### BACKGROUND

Efficiently jumping to different parts of content can be difficult, especially if the piece of content is lengthy in duration. If a user desires to hop to a particular part of a piece of content, he estimates where in the content the scene is he wishes to view, views a few seconds of content at the estimated location, then adjusts his estimate, repeating these steps multiple times until he locates the desired portion of the content. If the user misremembers the chronology of various scenes of the content, it may be time-consuming and aggravating for the user to locate the desired content portion. Further, if the user wishes to view multiple portions of the content, he may be forced to repeat this process several times.

### SUMMARY

Various systems, video playback devices, television receivers, and methods are presented for managing video content navigation. Metadata may be acquired that designates one or more portions of a programming content item as mapped to a predefined category selected from a plurality of predefined categories. The programming content item for may be output for playback. A scrub bar interface may be output as an overlay over the programming content item, wherein the scrub bar interface graphically indicates a start point of the programming content, an end point of the programming content, and a scrub bar spanning from the start point to the end point. The metadata that designates the portion of the programming content item as mapped to the predefined category may be accessed. One or more graphical indications of the predefined category on the scrub bar may be output based on the metadata, wherein the one or more graphical indications identify the one or more portions of the programming content item that map to the predefined category.

Various arrangements of such embodiments may include one or more of the following features: User input indicating a chapter-based forward jump or skip may be received. In response to the chapter-based forward jump, playback may be jumped to a start of a chronologically next portion of the one or more portions of the programming content item that maps to the predefined category. User input indicating a chapter-based backward jump or skip may be received. In response to the chapter-based backward jump, playback may be jumped or skipped to a start of a chronologically previous portion of the one or more portions of the programming content item that maps to the predefined category. Selection of the predefined category from the plurality of predefined categories may be received, wherein the one or more graphical indications of the predefined category on the scrub bar are output based on the metadata and the selection by the user of the predefined category from the plurality of predefined categories. The scrub bar interface may be output without the one or more graphical indications of the predefined category immediately prior to the selection of the predefined category from the plurality of predefined categories received from the user. The metadata may designates different portions of the programming content item as mapped to at least a first predefined category and the second predefined category selected from the plurality of predefined categories. Multiple graphical indications of the first predefined category and the second predefined category may be presented separately on the scrub bar based on the metadata. The multiple graphical indications may indicate multiple portions of the programming content item that map to the first predefined category and the second predefined category. Portions of the programming content item that map to the first predefined category may be presented as graphically different on the scrub bar from portions of the programming content item that map to the second predefined category.

Further, arrangements of such embodiments may additionally or alternatively include one or more of the following features: User input indicating selection of the first predefined category for chapter-based jumping functionality may be received (the second predefined category may not be selected). In response to the user input indicating selection of the first predefined category but not the second predefined category, chapter-based jumping may be enabled such that chapter-based jump commands cause jumping between portions of the programming content item that map to the first predefined category. The jumping may be performed irrespective of portions of the programming content item that map to the second predefined category. User input requesting the creation of an abbreviated video sequence file may be received. The abbreviated video sequence file may be created including the one or more portions of the programming content item designated by the metadata as mapping to the predefined category. The abbreviated video sequence file may be a bookmark file that defines playback of the programming content to include only the one or more portions of the programming content item. Category determinations may be collected by a host system from a plurality of video playback devices, wherein the category determinations identify one or more predefined categories from the plurality of predefined categories. The category determinations collected from the plurality of video playback devices may be compiled. Metadata may then be created based on the compiled determinations collected from the plurality of video playback devices.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a scrub bar interface that graphically identifies various portions of a piece of content that are classified within a category.

FIG. 2 illustrates an embodiment of a scrub bar interface that permits chapter-based jumping based on various portions of a piece of content being classified within a category.

FIG. 3 illustrates an embodiment of a scrub bar interface that graphically identifies various portions of a piece of content that are classified within multiple categories.

FIG. 4 illustrates an embodiment of a scrub bar interface that allows user input as to categories to be indicated on a scrub bar.

FIG. 5 illustrates an embodiment of a scrub bar interface that allows for creation of an abbreviated and chaptered sequence based on one or more category designations.

FIG. 6 illustrates an embodiment of a block diagram of a category-based scrub bar interface system.

FIG. 7 illustrates an embodiment of a method for providing a category-based scrub bar interface.

FIG. 8 illustrates an embodiment of a method for a category-based scrub bar interface that allows for navigation based on one or more category selections.

FIG. 9 illustrates an embodiment of a television service provider system that can be used to provide a category-based scrub bar interface.

FIG. 10 illustrates an embodiment of a television receiver that can provide a category-based scrub bar interface.

### DETAILED DESCRIPTION

A scrub bar allows a user to navigate quickly through video and/or audio content being presented on a video/audio playback device (e.g., tablet computer, television, mobile device, gaming device, smartphone, laptop computer, desktop computer, television receiver, set top box unit, etc.). A scrub bar interface can include a start location, an end location, a graphical element that can be referred to as a scrub bar extending from the start point to end point, and a current location indicator. The current location indicator indicates the location within the piece of content at which playback is currently occurring. Therefore, if the content is halfway through playback, the current location indicator would be halfway between the start and end points along the scrub bar; if the content is 90% of the way through playback, the current location indicator would be 90% closer to the end point than the start point along the scrub bar.

A scrub bar can facilitate user navigation within a piece of video and/or audio content. During playback, if a user wishes to hop to a particular location within a piece of content, the user may touch the scrub bar at the desired location or drag the current location indicator to the desired location. To facilitate navigation within the piece of content, portions of the piece of content that correspond to a particular predefined category can be indicated at the corresponding location on the scrub bar. The categories may correspond to various genres or types of content such as comedy, drama, love story, action, violence, suspense, dialog, nudity, commercial content, etc. The categories may be varied based on the type of content; for instance, a sporting event content item may have different categories than a movie. For sports, categories may be: live action, scoring plays, instant replay, dialog, official review, timeouts, etc. A piece of content may tend to have pieces of multiple types of categories within it (which can overlap): for example, a movie, that is overall categorized as an action movie, may have various portions that are: comedic, violent, and dialog. One or more of these portions may be denoted on the scrub bar. These portions may be exclusive and/or may partially or fully overlap.

Such designations on the scrub bar may help a user locate either these particular portions or scenes or portions or scenes occurring relative to the particular portions or scenes. For instance, a user may wish to jump to a particular scene in the movie involving his favorite actress. He may remember that the particular scene occurs just after a lengthy period of dialog. Therefore, to jump to the particular scene, he may locate on the scrub bar the portion of the content indicated on the scrub bar as associated with the lengthy period of dialog and use the scrub bar to jump to the location within the content immediately following the dialog.

The scrub bar interface may allow a user to specify which one or more categories are desired to be indicated on the scrub bar. The scrub bar may be then updated in real time (e.g., immediately) to indicate the one or more specified categories.

Jumping may be enabled based on the portions of the content that correspond to the one or more selected categories. Therefore, rather than jumping based on specific content-provider defined chapters (which are typically based on scenes within a piece of content), between portions of the content associated with the one or more selected categories as indicated on the scrub bar can be enabled. Therefore, this arrangement may allow a user to quickly view and jump between, for example, all of the comedic scenes within a movie.

While the embodiments detailed herein are focused on navigation of video content, it should be understood that in other embodiments similar arrangements may be used for navigating audio content. Therefore, a device could present a scrub bar interface that allows for navigation of audio only content, such as a radio program, audiobook, podcast, or some other form of audio content in which a user may wish to navigate.

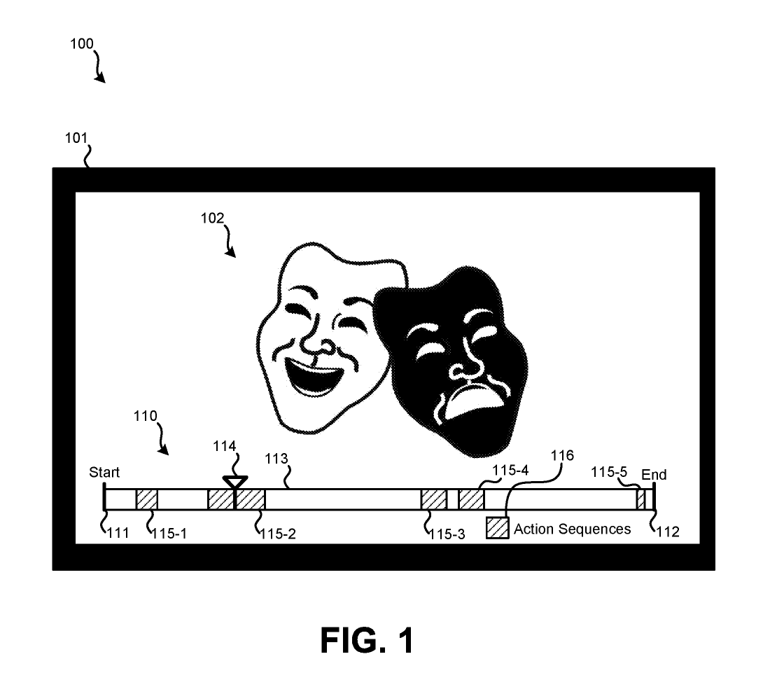

The above concepts along with other aspects of the embodiments are detailed in relation to the figures. FIG. 1 illustrates an embodiment 100 of a scrub bar interface that graphically identifies various portions of a piece of content (e.g., movie, episodic show, news event, sporting event, infomercial, etc.) that are classified as corresponding to a category. Video playback device 101 can present scrub bar interface 110. Video playback device 101 may be a tablet computer, television, mobile device, gaming device, smartphone, laptop computer, desktop computer, monitor, or some other form of video (and possibly audio) device. Video playback device 101 may present scrub bar interface 110 as an overlay over video content 102. In some arrangements, scrub bar interface 110 is overlaid over the video content that scrub bar interface 110 is used to navigate. Therefore, as scrub bar interface 110 is used to navigate through video content, the portion of the video content 102 over which the scrub bar interface is overlaid may change to correspond to a current location within the content indicated by scrub bar interface 110. In other embodiments, scrub bar interface 110 may be presented wholly independent of video content 102.

Scrub bar interface 110 may include: start point 111, end point 112, scrub bar 113, and current playback location indicator 114. Start point 111 may indicate the beginning of a piece of video content currently being or to be output for presentation. End point 111 may indicate the end of the piece of video content currently being or to be output for presentation. Scrub bar 113 may span from start point 111 to end point 112. Scrub bar 113, along with current playback location indicator 114, may serve as a graphical representation of a current playback position within the piece content. Current playback location indicator 114 may indicate the location within the piece of content currently being output for presentation. Therefore, as playback progresses, current playback location indicator 114 may move along scrub bar 113 towards end point location 112 from start point location 111. A user may provide input to scrub bar 113 or current playback location indicator 114 to navigate within the piece of content being played back or to be played back. For instance, in a touchscreen-based video playback device, a user may drag current playback location indicator 114 to a different location along scrub bar 113. Alternatively, the user may touch scrub bar 113 at a location from which he desires playback to occur. For non-touch based video interface devices, a user may use a user interface, such as a keyboard, mouse, or other pointing device to interact with scrub bar interface 110.

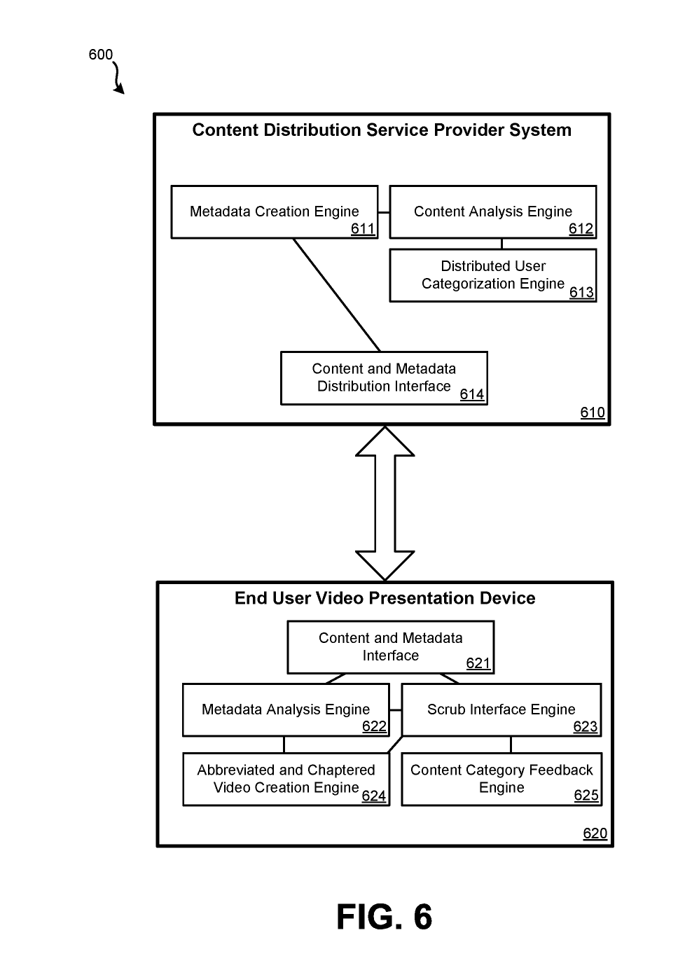

Portions 115 of scrub bar 113 are emphasized. Emphasized portions 115 (115-1, 115-2, 115-3, 115-4, and 115-5) correspond to the category of action sequences as defined by accessed metadata. This category of “action” is noted based on key indicator 116. When playback is occurring while current playback location indicator 114 is within any of portions 115, a viewer can expect the video content to correspond to an action sequence. Since current playback location indicator 114 is within portion 115-2, the currently output video content 102 can be expected to correspond to an action sequence. The length of portions 115 along scrub bar 113 may directly correspond to the duration of the action sequences. Therefore, a shorter portion of scrub bar 113 being emphasized, such as portion 115-5, can correspond to a shorter action sequence as compared to portion 115-2. Further detail regarding the metadata used to define the emphasized portions of scrub bar interface 110 is provided in relation to FIG. 6.

The emphasis on portions 115 of scrub bar 113 may be represented by portions 115 being displayed in a different color than a remainder of scrub bar 113, such as via highlighting. It should be understood that other forms of emphasis may be used instead of coloring.

It should be understood that the illustrated embodiment 100 is merely exemplary. The specific graphical elements of scrub bar interface 110 may be varied based on the particular implementation. For instance, the location of scrub bar interface 110; the look, shape, and sizing of various elements (such as current playback location indicator 114); and the coloring scheme of scrub bar interface 110 may be significantly varied by embodiment.

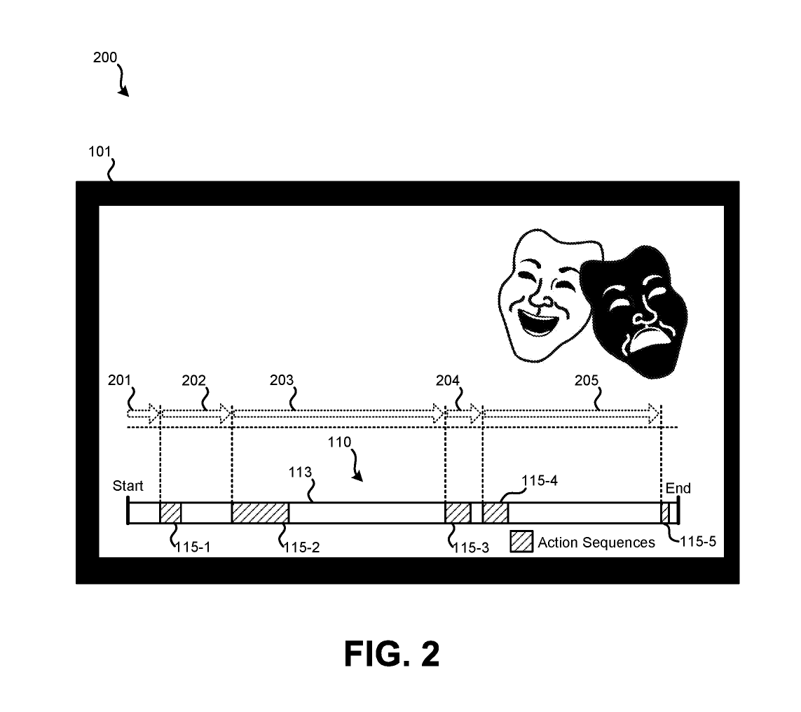

FIG. 2 illustrates an embodiment 200 of scrub bar interface 110 that permits jumping based on various portions of a piece of content being classified within a category currently emphasized on the scrub bar. When a particular category within a piece of content is indicated on scrub bar interface 110, jump-based navigation may be enabled based on the location of portions corresponding to the emphasized category. Referring to FIG. 2, if playback has not begun or is currently at or near start point 111, a user providing a (chapter) jump or fast-forward command may cause playback to jump to a start of portion 115-1, as indicated by arrow 201. A subsequent jump or fast-forward command may cause playback to jump to the start of portion 115-2, as indicated by arrow 202. A subsequent jump or fast-forward command may cause playback to jump to the start of portion 115-3, as indicated by arrow 203. A subsequent jump or fast-forward command may cause playback to jump to the start of portion 115-4, as indicated by arrow 204. A subsequent jump or fast-forward command may cause playback to jump to the start of portion 115-5, as indicated by arrow 205. Reverse jump or rewind commands received may cause jumping among the same locations in the reverse direction. Therefore, scrub bar interface 110 may permit portions of a piece of content indicated as corresponding to a category to be quickly navigated to using jump commands. When scrub bar interface 110 is not active, chapter-based jump commands may instead enable jumping between predefined chapters within the video content.

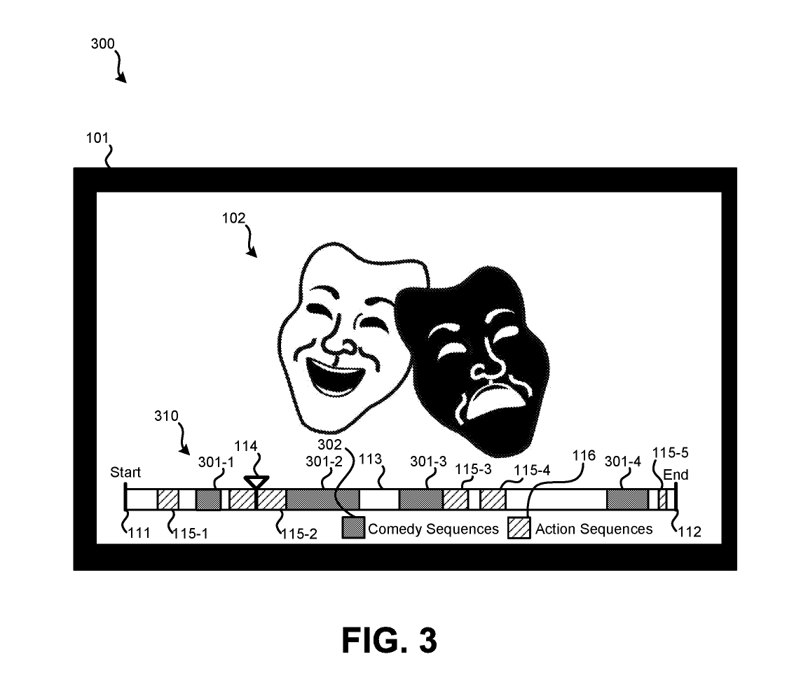

FIG. 3 illustrates an embodiment 300 of a scrub bar interface that graphically identifies various portions of a piece of content that are classified within multiple categories. On scrub bar interface 310, portions 115 of scrub bar 113 are emphasized as mapped to action sequences of the piece of content being presented and portions 301 (301-1, 301-2, 301-3, 301-4) of scrub bar 113 are emphasized and associated with comedy sequences. Key indicators 116 and 302 differentiate how comedy sequences are emphasized as opposed to action sequences such that a viewer can tell these portions apart (e.g., by color or line pattern). By a viewer viewing scrub bar interface 310, the viewer can identify portions of the piece of content that are associated with comedy sequences and action sequences.

In the illustrated embodiment 300, comedy sequences are indicated on scrub bar interface 310 as exclusive from action sequences. However, in other embodiments, portions of the comedy sequences and action sequences may partially or fully overlap. Such overlap may be indicated by using a third type of emphasis indicative of both comedy and action. As an example, if a first color is used to emphasize comedy sequences and a second color is used to emphasize action sequences, a third color, which may be between the first and second colors on a color spectrum, may be used for portions that can be categorized as both comedy and action. As should be understood, other forms of emphasis may be used to identify portions of content that can fall into multiple categories.

While FIG. 3 illustrates two types of categories of portions of content being emphasized on scrub bar interface 110, it should be understood that greater numbers of categories may be emphasized. For example, between 3 and 10 categories of content may be emphasized on the scrub bar interface.

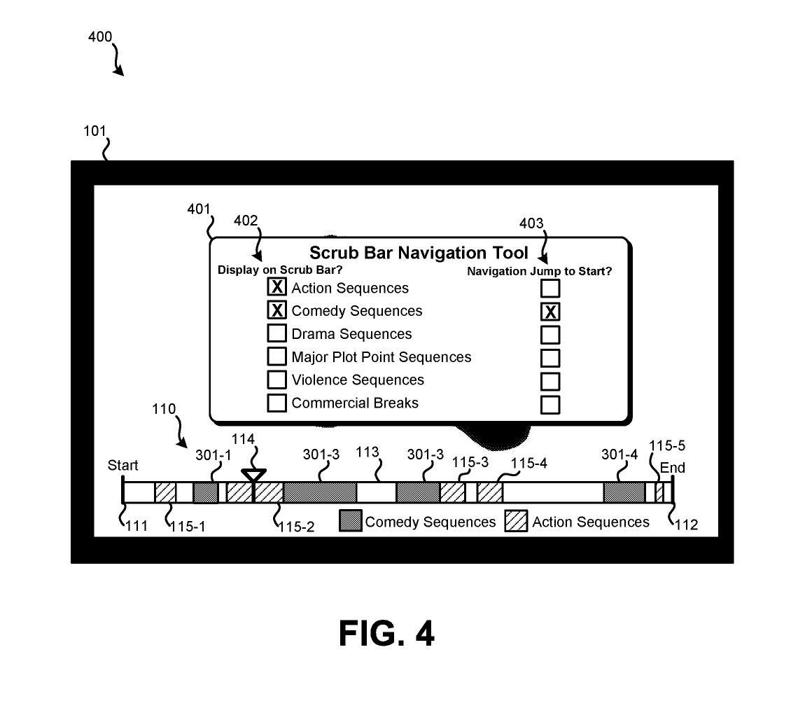

FIG. 4 illustrates an embodiment 400 of a scrub bar interface that allows user input to define one or more categories to be indicated on a scrub bar. While FIGS. 1-3 show a scrub bar interface emphasizing particular categories of portions of content, FIG. 4 illustrates how a user may specify which one or more categories the user wants emphasized on the scrub bar interface. Using scrub bar navigation tool 401, a user may define whether a particular category of portions of content is presented on scrub bar interface 110. Each of the available categories may be predefined. The available categories may vary based on the specific piece of content or the type of content being output for presentation. For instance, the categories available for display in selection region 402 may vary if the type of content is sports programming as opposed to a movie. In illustrated embodiment 400, a user has selected action sequences and comedy sequences, as such scrub bar interface 110 presents emphasis on the scrub bar corresponding to portions of the piece of content that have been categorized as comedy sequences and action sequences. Other portions along the scrub bar remain un-emphasized. Any changes to selection in selection region 402 may result in updates being performed to scrub bar 113 in order to emphasize the currently selected categories. As such, changes made in selection region 402 may immediately be reflected in the emphasis indicated on scrub bar interface 110.

Selection region 403 may allow a user to specify whether navigational jumps result in jumping to the start of the corresponding categorized portions. In embodiment 400, comedy sequences are noted for navigation jumps, but not action sequences. Therefore, navigation as detailed in relation to embodiment 200 would be performed for jumps between comedy sequence portions but not action sequence portions. In contrast, if both comedy and action were selected in selection region 403, a user-input jump command would jump to the next comedy or action portion of the content, depending on which category occurred chronologically next or previously, depending on the direction of the jump command. Individual items of selection region 403 may only be enabled for selection if a corresponding item causing presentation on the scrub bar has been selected in selection region 402.

While selection region 402 illustrates various categories, it should be understood that these categories are merely exemplary, and various other categories are possible. Similarly, the visual design of scrub bar navigation tool 401 is merely an example; the location, arrangement, and particulars of the interface can vary by embodiment. While embodiment 400 allows a user to define the categories presented on scrub bar interface 110 and the locations to which navigational jumps are performed, it should be understood that in other embodiments, a service provider may define which categories are presented on scrub bar interface 110 and how navigational jumping is performed in relation to the emphasized and non-emphasized portions of the content.

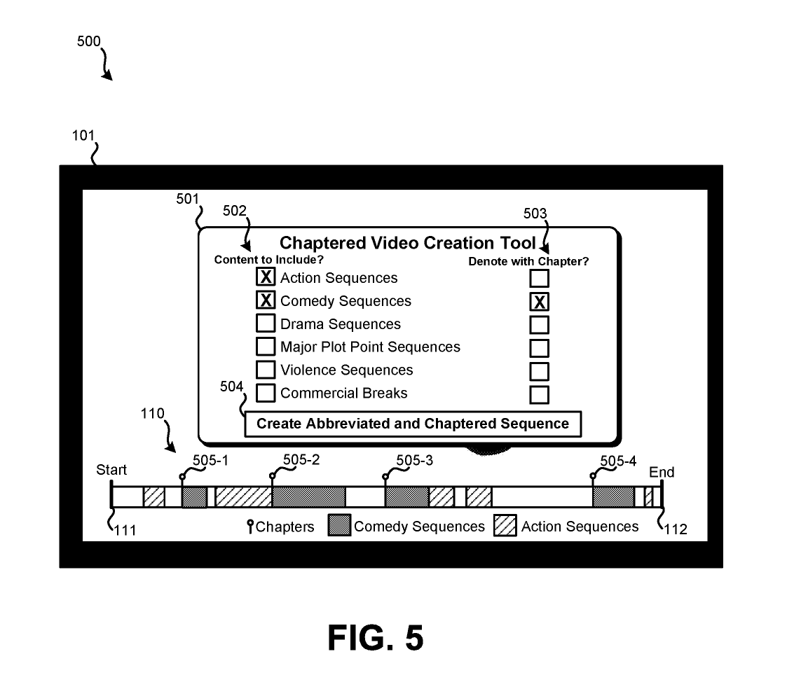

FIG. 5 illustrates an embodiment 500 of a scrub bar interface that allows for creation of an abbreviated and chaptered sequence based on one or more category designations. In embodiment 500, as in embodiments 100, 200, 300 and 400, a scrub bar interface is presented. However, in embodiment 500, chaptered video creation tool 501 allows for an abbreviated and chaptered sequence of video (and, possibly, audio) to be created based on the emphasized portions on the scrub bar. Just as in embodiment 400, a user can use selection interface 502 to select particular categories of content to be included in the abbreviated and chaptered video sequence. Unselected portions of the piece of content may be omitted from the sequence. Therefore, a created sequence may function as a highlight reel of, in embodiment 500, comedy and action sequences of a piece of content. Selection interface 503 may indicate whether the corresponding categories should be denoted by chapter metadata, which can enable jumping between such portions. That is, some video playback devices include a chapter jump or skip button that allows fast jumping or skipping between chapters of a piece of content during playback. Chapter locations are indicated on scrub bar interface 110 by chapter indications 505. In response to user selection of the chapter indication in selection interface 503, chapter indications 505 may be added to scrub bar interface 110. As such, scrub bar interface 110 reflects the portions of content and chapter locations of the video to be created upon selection of element 504.

Embodiment 500 may be available to a user to create an abbreviated and chaptered video sequence from a previously-recorded or stored piece of content. Alternatively, if a user desires to record a piece of content from a broadcast, chaptered video creation tool 501 may be used to select which portions of the content is recorded by the device receiving the piece of content. Portions of the piece of content not associated with the one or more selected categories, as indicated on scrub bar interface 110, may not be recorded.

Selection of element 504 may result in a video (and/or audio) file being created that includes only the selected categories and chapter notations. Therefore, portions of the content that are not emphasized on scrub bar interface 110 may be omitted from the created abbreviated and chaptered video sequence. In some embodiments, rather than creating a separate video and/or audio file, a bookmark or metadata file may be created that allows for playback of an abbreviated and chaptered sequence from a file containing the complete piece of content.

FIG. 6 illustrates a block diagram of an embodiment of a category-based scrub bar interface system 600. Embodiment 600 can include: content distribution service provider system 610 and end user video presentation device 620. While content distribution service provider system 610 is shown in communication with a single end user video presentation device 620, it should be understood this is merely for simplicity; content distribution service provider system 610 may be in communication with a large number of end user video presentation devices. Content distribution service provider system 610 may be operated by a content distribution service provider, such as a streaming and/or broadcast television service provider. Content distribution service provider system 610 may include: metadata creation engine 611, content analysis engine 612, distributed user categorization engine 613, and content and metadata distribution interface 614. These components may be performed using one or more server systems that may be distributed.

Metadata creation engine 611 may serve to create the metadata that can be used to emphasize certain portions of a scrub bar corresponding to a piece of content. Metadata creation engine 611 may create a file that indicates locations, which can be based on time or file location, and an associated category. The category can be selected from a list of predefined categories. As an example, Table 1 illustrates example entries for a metadata file created by metadata creation engine 611 for a piece of content:

TABLE 1

| Metadata Category | Start Time | End Time |
|---|---|---|
| Comedy | 12:34 | 13:31 |
| Action | 17:00 | 17:58 |
| Action | 1:01:27 | 1:05:13 |
| Comedy | 1:22:59 | 1:25:12 |

In some embodiments, rather than a metadata table or metadata file being created for a piece of content, metadata tags may be inserted in a piece of content such that, when an end user video presentation device receives a piece of streaming content, metadata tags are inserted within the piece of content at the locations indicative of the corresponding categorical portions of the piece of content. For example, a first metadata instance may signal the start of a comedic portion within a streaming or broadcast piece of content and a subsequent second metadata instance may signal the end of the comedic portion within the piece of content.

While metadata creation engine 611 may create data similar to that of Table 1 or may insert metadata in a streaming instance of a piece of content, content analysis engine 612 may analyze a piece of content to determine portions of the piece of content that correspond to the various metadata categories available. Content analysis engine 612 may involve a human operator viewing the piece of content and manually selecting portions of the content that correspond to the various metadata categories. In other embodiments, distributed user categorization engine 613 may be used to receive feedback of multiple viewers of a piece of content from end user video presentation devices to determine portions of the piece of content that correspond to the various available metadata categories.

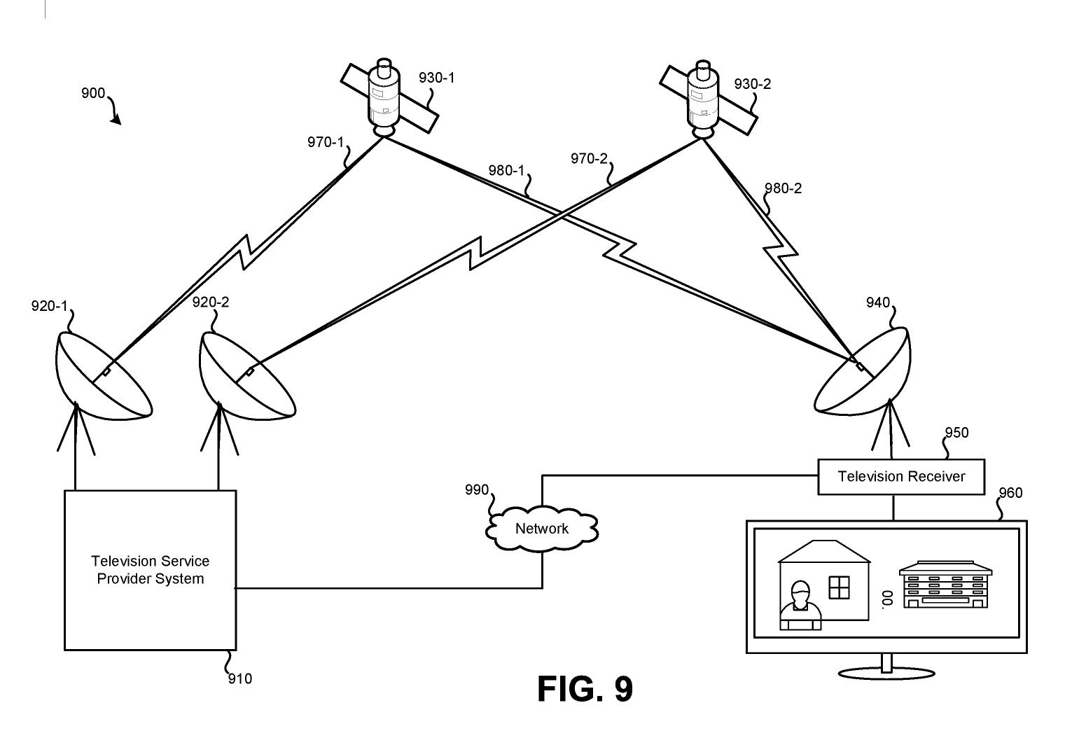

Content and metadata distribution interface 614 may be used to distribute the piece of content and metadata created by metadata creation engine 611. Content and metadata distribution interface 614 may transmit content and metadata via an IP-based network such as the Internet. Content and metadata distribution interface 614 may also distribute content and metadata via another form of communication, such as a television service provider system as detailed in relation to FIG. 9.

End user video presentation device 620, which may be a tablet computer, television, mobile device, gaming device, smartphone, laptop computer, desktop computer, or television receiver (e.g., set top box), may receive content and metadata via content and metadata interface 621. Content and metadata interface 621 may be a wireless or wired network communication interface or tuner. Metadata analysis engine 622 may analyze metadata received from content distribution service provider system 610. Scrub interface engine 623 may create a scrub bar interface, such as scrub bar interface 110, based on metadata analyzed by metadata analysis engine 622. Emphasis on the scrub bar may only be presented for particular categories that have been selected by a user. Abbreviated and chaptered video creation engine 624 may create an abbreviated and chaptered video as detailed in relation to the embodiment of FIG. 5 based on the analyzed metadata. Content category feedback engine 625 may allow an end-user to provide feedback to distributed user categorization engine 613 that can be used for creating metadata. For instance, content category feedback engine 625 may occasionally ask, via a visual or audio interface, a user whether a portion of a piece of content currently being played back corresponds to a category. Content category feedback engine 625 may present an interface that allows a user to select the category from a list of predefined categories. An indication of a selected category may be transmitted to distributed user categorization engine 613 along with an indication of the location within the piece of content at which the user made the selection. If enough end users categorize this portion of the piece of content with the same category designation, distributed user categorization engine 613 can instruct metadata creation engine 611 to create metadata such that a scrub bar interface presented by end user video presentation devices during future playback of the piece of content indicates that portion of the piece of content as being mapped to the category.

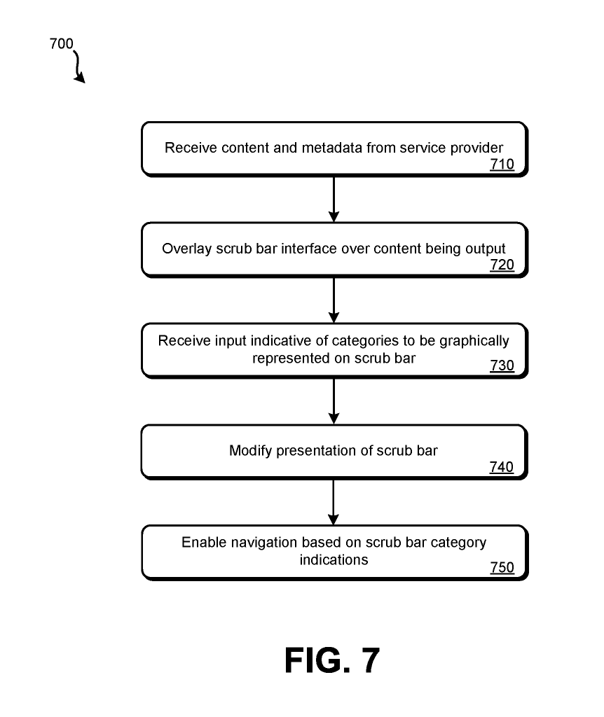

FIG. 7 illustrates an embodiment of a method 700 for providing a category-based scrub bar interface. Method 700 may be performed using the interfaces, systems, and devices detailed in relation to FIGS. 1-6, 9, and 10. Specifically, each step of method 700 may be performed by a video playback device. At block 710, content and metadata may be received by the video playback device from a content service provider. The content and metadata may be distributed to the video playback device separately.

At block 720, a scrub bar interface may be overlaid over the piece of content while the piece of content is being output by the video playback device. In other embodiments, the scrub bar interface may be presented separate from the piece of content (e.g., not as an overlay) or may be presented when the piece of content is not currently being played back (e.g., prior to a user initiating playback of the piece of content). At block 730, input may be received that is indicative of categories to be graphically represented on the scrub bar. This input may be received from the service provider or from a user of the video playback device. For example, such input may be provided by user via an interface such as that presented in FIG. 4. At block 740, presentation of the scrub bar interface may be modified to indicate portions of the piece of content that map to the category or categories indicated at block 730. The portions of the scrub bar that are emphasized may be based on the received metadata of block 710. At block 750, navigation may be enabled based on the emphasized portions of the scrub bar such that jump commands received by the video playback device cause jumping within the piece of content among the portions of content corresponding to the emphasized portions of the scrub bar.

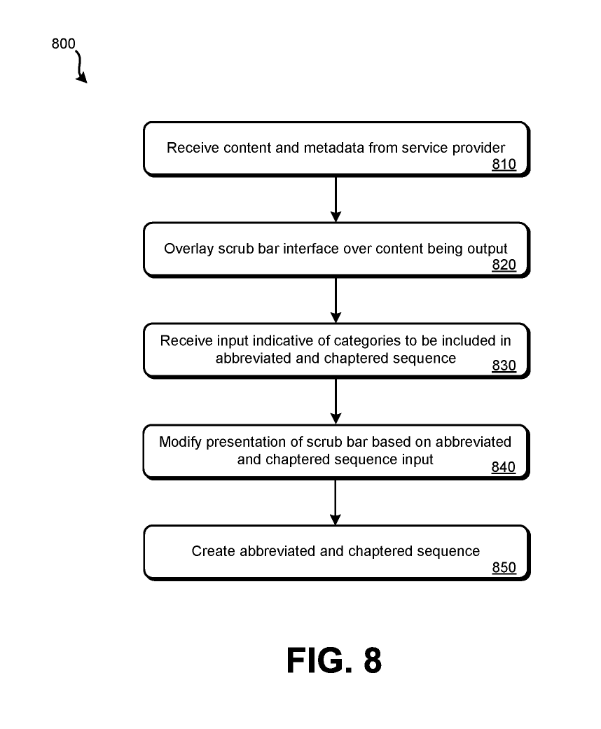

FIG. 8 illustrates an embodiment of a method 800 for a category-based scrub bar interface that allows for navigation based on one or more category selections. Method 800 may be performed using the interfaces and devices detailed in relation to FIGS. 1-6, 9, and 10. A video playback device may perform each step of method 800. At block 810, content and metadata may be received by the video playback device from a content service provider. The content and metadata may be distributed to the video playback device separately, such as in separate files or, for instance, the content may be broadcast and recorded by the video playback device and the metadata may be sent at a later time. Alternatively, the metadata may be embedded in a data stream of the content.

At block 820, a scrub bar interface may be overlaid over the piece of content while the piece of content is being output by the video playback device. At block 830, input may be received that is indicative of categories of content to be included in abbreviated and chaptered sequence. This input may be received from the service provider or from a user of the video playback device. For example, such input may be provided by the user via an interface such as that presented in FIG. 5. At block 840, presentation of the scrub bar interface may be modified to indicate portions of the piece of content that correspond to the category or categories indicated at block 830 and will be included in the abbreviated and chaptered sequence. The portions of the scrub bar that are emphasized may be based on the received metadata of block 810. At block 850, the abbreviated and chaptered sequence may be created by creating a new video (and/or audio) file that includes on the portions of the content emphasized on the scrub bar. Navigation may be enabled to allow for jump commands among the beginnings of the portions of the piece of content included in the abbreviated sequence. In some embodiments, rather than creating a separate video and/or audio file, a bookmark or metadata file may be created that enables playback of an abbreviated and chaptered sequence from the complete piece of content based on the one or more categories indicated at block 830.

FIG. 9 illustrates an embodiment of a television service provider system that can be used to provide a category-based scrub bar interface. While embodiments detailed herein may be applied to various television distribution systems, including cable and IP, a satellite television distribution system is provided as an example. Satellite television distribution system 900 may include: television service provider system 910, satellite transmitter equipment 920, satellites 930, satellite dish 940, television receiver 950, and display device 960. Alternate embodiments of satellite television distribution system 900 may include fewer or greater numbers of components. While only one satellite dish 940, television receiver 950, and display device 960 (collectively referred to as “user equipment”) are illustrated, it should be understood that multiple (e.g., tens, thousands, millions) instances of user equipment may receive television signals from satellites 930.

In the illustrated embodiment of FIG. 9, television service provider system 910 may function as content distribution service provider system 610 and television receiver 950 can function as end user video presentation device 620. As disclosed in relation to FIG. 6, the content distribution service provider system may use a network (e.g., network 99), such as the Internet, to communicate with an end user video presentation device or a separate, dedicated television service provider network, such as a satellite-based television service provider network.

Television service provider system 910 and satellite transmitter equipment 920 may be operated by a television service provider. A television service provider may distribute television channels, on-demand programming, programming information, and/or other services to users. Television service provider system 910 may receive feeds of one or more television channels from various sources. Such television channels may include multiple television channels that contain the same content (but may be in different formats, such as high-definition and standard-definition). To distribute such television channels to users, feeds of the television channels may be relayed to user equipment via one or more satellites via transponder streams. Satellite transmitter equipment 920 may be used to transmit a feed of one or more television channels from television service provider system 910 to one or more satellites 930. While a single television service provider system 910 and satellite transmitter equipment 920 are illustrated as part of satellite television distribution system 900, it should be understood that multiple instances of transmitter equipment may be used, possibly scattered geographically to communicate with satellites 930. Such multiple instances of satellite transmitting equipment may communicate with the same or with different satellites. Different television channels may be transmitted to satellites 930 from different instances of transmitting equipment. For instance, a different satellite dish of satellite transmitter equipment 920 may be used for communication with satellites in different orbital slots.

Satellites 930 may be configured to receive signals, such as streams of television channels, from one or more satellite uplinks such as satellite transmitter equipment 920. Satellites 930 may relay received signals from satellite transmitter equipment 920 (and/or other satellite transmitter equipment) to multiple instances of user equipment via transponder streams. Different frequencies may be used for uplink signals 970 from transponder stream 980. Satellites 930 may be in geosynchronous orbit. Each satellite 930 may be in a different orbital slot, such that the signal paths between each satellite, transmitter equipment, and user equipment vary. Multiple satellites 930 may be used to relay television channels from television service provider system 910 to satellite dish 940. Different television channels may be carried using different satellites. Different television channels may also be carried using different transponders of the same satellite; thus, such television channels may be transmitted at different frequencies and/or different frequency ranges. As an example, a first and second television channel may be carried on a first transponder of satellite 930-1. A third, fourth, and fifth television channel may be carried using a different satellite or a different transponder of the same satellite relaying the transponder stream at a different frequency. A transponder stream transmitted by a particular transponder of a particular satellite may include a finite number of television channels, such as seven. Accordingly, if many television channels are to be made available for viewing and recording, multiple transponder streams may be necessary to transmit all of the television channels to the instances of user equipment.

Satellite dish 940 may be a piece of user equipment that is used to receive transponder streams from one or more satellites, such as satellites 930. Satellite dish 940 may be provided to a user for use on a subscription basis to receive television channels provided by the television service provider system 910, satellite transmitter equipment 920, and/or satellites 930. Satellite dish 940 may be configured to receive transponder streams from multiple satellites and/or multiple transponders of the same satellite. Satellite dish 940 may be configured to receive television channels via transponder streams on multiple frequencies. Based on the characteristics of television receiver 950 and/or satellite dish 940, it may only be possible to capture transponder streams from a limited number of transponders concurrently. For example, a tuner of television receiver 950 may only be able to tune to a single transponder stream from a transponder of a single satellite at a time.

In communication with satellite dish 940 may be one or more sets of receiving equipment. Receiving equipment may be configured to decode signals received from satellites 930 via satellite dish 940 for display on a display device, such as display device 960. Receiving equipment, including a television receiver, may be incorporated as part of a television or may be part of a separate device, commonly referred to as a set-top box (STB). Receiving equipment may include a satellite tuner configured to receive television channels via a satellite. In FIG. 9, receiving equipment is present in the form of television receiver 950. As such, television receiver 950 may decode signals received via satellite dish 940 and provide an output to display device 960. FIG. 2 provides additional detail of a television receiver. A television receiver is defined to include set-top boxes (STBs) and circuitry having similar functionality that may be incorporated with another device. For instance, circuitry similar to that of a television receiver may be incorporated into a television. As such, while FIG. 9 illustrates an embodiment of television receiver 950 as separate from display device 960, it should be understood that in other embodiments, similar functions may be performed by a television receiver integrated with display device 960.

Display device 960 may be used to present video and/or audio decoded by television receiver 950. Television receiver 950 may also output a display of one or more interfaces to display device 960, such as an electronic programming guide (EPG). Display device 960 may be a television. In some embodiments, a display device other than a television may be used, such as a monitor.

Uplink signal 970-1 represents a signal between satellite transmitter equipment 920 and satellite 930-1. Uplink signal 970-2 represents a signal between satellite transmitter equipment 920 and satellite 930-2. Each of uplink signals 970 may contain streams of one or more different television channels. For example, uplink signal 970-1 may contain a certain group of television channels, while uplink signal 970-2 contains a different grouping of television channels. Each of these television channels may be scrambled such that unauthorized persons are prevented from accessing the television channels.

Transponder stream 980-1 represents a signal between satellite 930-1 and satellite dish 940. Transponder stream 980-2 represents a signal path between satellite 930-2 and satellite dish 940. Each of transponder streams 980 may contain one or more different television channels in the form of transponder streams, which may be at least partially scrambled. For example, transponder stream 980-1 may include a first transponder stream containing a first group of television channels, while transponder stream 980-2 may include a second transponder stream containing a different group of television channels. A satellite may transmit multiple transponder streams to user equipment. For example, a typical satellite may relay thirty-two transponder streams via corresponding transponders to user equipment. Further, spot beams are possible. For example, a satellite may be able to transmit a transponder stream to a particular geographic region (e.g., to distribute local television channels to the relevant market). Different television channels may be transmitted using the same frequency of the transponder stream to a different geographic region.

FIG. 9 illustrates transponder stream 980-1 and transponder stream 980-2 being received by satellite dish 940. For a first group of television channels, satellite dish 940 may receive a transponder stream of transponder stream 980-1; for a second group of channels, a transponder stream of transponder stream 980-2 may be received. Television receiver 950 may decode the received transponder stream. As such, depending on which television channel(s) are desired, a transponder stream from a different satellite (or a different transponder of the same satellite) may be accessed and decoded by television receiver 950. Further, while two satellites are present in satellite television distribution system 900, in other embodiments greater or fewer numbers of satellites may be present for receiving and transmitting transponder streams to user equipment.

Network 990 may serve as a secondary communication channel between television service provider system 910 and television receiver 950. Via such a secondary communication channel, bidirectional exchange of data may occur. As such, data may be transmitted to television service provider system 910 via network 990. Data may also be transmitted from television service provider system 910 to television receiver 950 via network 990. Network 990 may be the Internet. While audio and video services may be provided to television receiver 950 via satellites 930, feedback from television receiver 950 to television service provider system 910 may be transmitted via network 990.

FIG. 9 illustrates an example of a satellite-based television channel distribution system. It should be understood that at least some of the aspects of such a system may be similar to a cable television distribution system. For example, in a cable television system, rather than using satellite transponders, multiple RF channels on a cable may be used to transmit streams of television channels. Aspects detailed herein may be applicable to cable television distribution systems and IP-based content distribution systems.

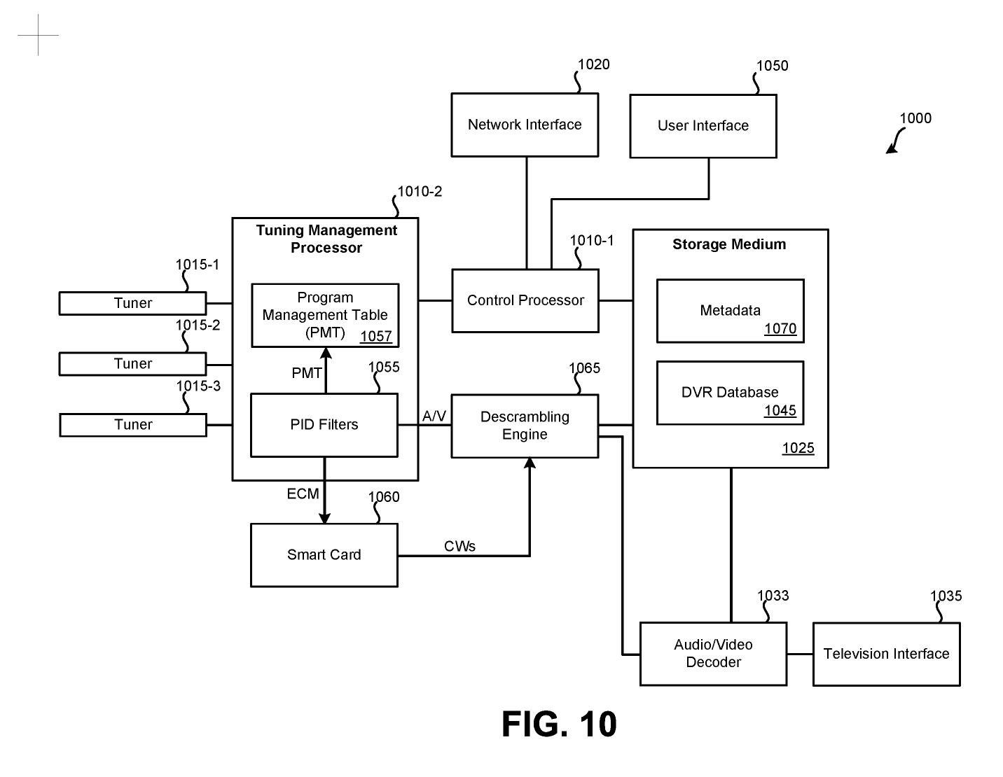

FIG. 10 illustrates an embodiment of a television receiver 1000 that can provide a category-based scrub bar interface as detailed in relation to FIGS. 1-8. Television receiver 1000 may function as a video presentation device that outputs video to a television. Embodiments of television receiver 1000 may include set top boxes (STBs). In addition to being in the form of an STB, a television receiver may be incorporated into another device, such as a television. For example, a television may have an integrated television receiver (which does not involve an external STB being coupled with the television). An STB may contain some or all of the components of television receiver 1000 and/or may be able to perform some or all of the functions of television receiver 1000.

Television receiver 1000 may be the television receiver of FIG. 9 and may be in the form of an STB that communicates with a display device such as a television. Television receiver 1000 may be incorporated as part of a television. Television receiver 1000 may include: processors 1010 (which may include control processor 1010-1 and tuning management processor 1010-2), tuners 1015, network interface 1020, non-transitory computer-readable storage medium 1025, electronic programming guide (EPG) database 1030, television interface 1035, networking information table (NIT) 1040, digital video recorder (DVR) database 1045, PID filters 1055, smart card 1060, and/or descrambling engine 1065. In other embodiments of television receiver 1000, fewer or greater numbers of components may be present. It should be understood that the various components of television receiver 1000 may be implemented using hardware, firmware, software, and/or some combination thereof. Functionality of components may be combined; for example, functions of descrambling engine 1065 may be performed by tuning management processor 1010-2. Further, functionality of components may be spread among additional components; for example, PID filters 1055 may be handled by separate hardware from program management table 1057.

Processors 1010 may include one or more specialized and/or general-purpose processors configured to perform processes such as tuning to a particular channel, accessing and displaying EPG information, outputting user interfaces, and/or receiving and processing input from a user. For example, processors 1010 may include one or more processors dedicated to decoding video signals from a particular format, such as MPEG, for output and display on a television and for performing decryption. It should be understood that the functions performed by various modules of FIG. 10 may be performed using one or more processors. As such, for example, functions of descrambling engine 1065 may be performed by control processor 1010-1.

Control processor 1010-1 may communicate with tuning management processor 1010-2. Control processor 1010-1 may control the recording of television channels based on timers stored in DVR database 1045 or in a separate file structure by storage medium 1025 (e.g., a file may be used to store indications of each type of time). Control processor 1010-1 may initiate recording of a television channel by sending a record command along with an indication of the television channel to be recorded to tuning management processor 1010-2. Control processor 1010-1 may not send a second record command (if additional recording is to begin at the same time) until an acknowledgement that recording of the first television channel has successfully been received and initiated by tuning management processor 1010-2. Control processor 1010-1 may also provide commands to tuning management processor 1010-2 when recording of a television channel is to cease. In addition to providing commands relating to the recording of television channels, control processor 1010-1 may provide commands to tuning management processor 1010-2 that indicate television channels to be output to audio/video decoder 1033 for output to a presentation device, such as a television.

Control processor 1010-1 may also communicate with network interface 1020 and user interface 1050. Control processor 1010-1 may handle data from network interface 1020. Additionally, control processor 1010-1 may be configured to output data via network interface 1020.

Tuners 1015 may include one or more tuners used to tune to television channels, such as television channels transmitted via satellite or cable. In the illustrated embodiment of television receiver 1000, three tuners are present (tuner 1015-1, tuner 1015-2, and tuner 1015-3). Each tuner contained in tuners 1015 may be capable of receiving and processing a single stream of data from a satellite transponder (or a cable RF channel) at a given time. As such, a single tuner may tune to a single transponder (or, for a cable network, a single cable RF channel). If tuners 1015 include multiple tuners, one tuner may be used to tune to a television channel on a first transponder stream for display using a television, while another tuner may be used to tune to a television channel on a second transponder for recording and viewing at some other time. Still another tuner may be used to check various television channels to determine if they are available or not. If multiple television channels transmitted on the same transponder stream are desired, a single tuner of tuners 1015 may be used to receive the signal containing the multiple television channels for presentation and/or recording. Tuners 1015 may receive commands from tuning management processor 1010-2. Such commands may instruct tuners 1015 which frequencies are to be used for tuning. Metadata may be received by tuners 1015. For instance, a stream of metadata may be transmitted to television receiver 1000 along with various pieces of content.

Network interface 1020 may be used to communicate via an alternate communication channel with a television service provider, such as to receive metadata. For example, the primary communication channel may be via satellite (which may be unidirectional to the STB) and the alternate communication channel (which may be bidirectional) may be via a network, such as the Internet. Referring back to FIG. 1, television receiver 950 may be able to communicate with television service provider system 910 via a network, such as the Internet. This communication may be bidirectional: data may be transmitted from television receiver 950 to television service provider system 910 and from television service provider system 910 to television receiver 950. Referring back to FIG. 10, network interface 1020 may be configured to communicate via one or more networks, such as the Internet, to communicate with television service provider system 910 of FIG. 1. Information may be transmitted and/or received via network interface 1020.

Storage medium 1025 may represent a non-transitory computer-readable storage medium. Storage medium 1025 may include memory and/or a hard drive. Storage medium 1025 may be used to store information received from one or more satellites and/or information received via network interface 1020. Storage medium 1025 may store information related to metadata 1070 and/or DVR database 1045. Recorded television programs may be stored using storage medium 1025. Storage medium 1025 may be partitioned or otherwise divided such that predefined amounts of storage medium 1025 are devoted to storage of omnibus channel files and user-selected television programs.

Storage medium 1025 may store received metadata 1070. Metadata 1070 may be received via tuners 1015 and/or network interface 1020. Metadata may be associated with a particular piece of content, which may be stored in DVR database 1045 or some other stored content database (either local or remote). This metadata may be used by control processor 1010-1 (or some other processor) in presenting a scrub bar interface with emphasized portions that correspond to specific portions of the piece of content being output.

Audio/video decoder 1033 may serve to convert encoded video and audio into a format suitable for output to a display device. For instance, audio/video decoder 1033 may receive MPEG video and audio from storage medium 1025 or descrambling engine 1065 to be output to a television. MPEG video and audio from storage medium 1024 may have been recorded to DVR database 1045 as part of a previously-recorded television program. Audio/video decoder 1033 may convert the MPEG video and audio into a format appropriate to be displayed by a television or other form of display device and audio into a format appropriate to be output from speakers, respectively.

Television interface 1035 may serve to output a signal to a television (or another form of display device) in a proper format for display of video and playback of audio. As such, television interface 1035 may output one or more television channels, stored television programming from storage medium 1025 (e.g., television programs from DVR database 1045) to a television for presentation.

DVR functionality of television receiver 1000 may be managed by control processor 1010-1. Control processor 1010-1 may coordinate the television channel, start time, and stop time of when recording of a television channel is to occur. DVR database 1045 may store information related to the recording of television stations. DVR database 1045 or some other storage arrangement (e.g., a separate file) may store timers that are used by control processor 1010-1 to determine when a television channel should be tuned to and its programs recorded to DVR database 1045 of storage medium 1025. In some embodiments, a limited amount of storage medium 1025 may be devoted to DVR database 1045. Timers may be set by the television service provider and/or one or more users of television receiver 1000.

The DVR functionality of control processor 1010-1 may have multiple modes. First, the DVR functionality of control processor 1010-1 may be configured to record individual television programs selected by a user to DVR database 1045. Based on the date, time period, and television channel indicated by EPG data, control processor 1010-1 may record the associated television program to DVR database 1045. Second, DVR database 1045 may be used to store recordings of predefined periods of time on one or more television channels. These predefined periods of time may include one or more television programs. For example, primetime on a particular television network may be recorded each weekday night. Further, multiple television channels may be recorded for such predefined periods of time. Such recording of television channels for predefined periods of time may be defined by the television service provider.

As an example of this second mode of DVR functionality, a television service provider may configure television receiver 1000 to record television programming on multiple, predefined television channels for a predefined period of time, on predefined dates. For instance, a television service provider may configure television receiver 1000 such that television programming may be recorded from 7 to 10 PM on NBC, ABC, CBS, and FOX on each weeknight. If a television program is selected for recording by a user (e.g., the user sets a recording timer for the television program) and is also specified for recording by the television service provider, the user selection for recording may serve as an indication to save the television program for an extended time (beyond the time which the predefined recording would otherwise be saved).

User interface 1050 may include a remote control (physically separate from television receiver 1000) and/or one or more buttons on television receiver 1000 that allow a user to interact with television receiver 1000. User interface 1050 may be used to select a television channel for viewing, present a scrub bar interface, and/or program a timer stored to DVR database 1045, wherein the timer is used to control the DVR functionality of control processor 1010-1.

Referring back to tuners 1015, television channels received via satellite (or cable) may contain at least some scrambled data. Packets of audio and video may be scrambled to prevent unauthorized users (e.g., nonsubscribers) from receiving television programming without paying the television service provider. When a tuner of tuners 1015 is receiving data from a particular transponder of a satellite, the transponder stream may be a series of data packets corresponding to multiple television channels. Each data packet may contain a packet identifier (PID), which, in combination with a network information table and/or PMT 1057, can be determined to be associated with a particular television channel. Particular data packets, referred to as entitlement control messages (ECMs), may be periodically transmitted. ECMs may be associated with another PID and may be encrypted; television receiver 1000 may use smart card 1060 to decrypt ECMs. Decryption of an ECM may only be possible if the user has authorization to access the particular television channel associated with the ECM. When an ECM is determined to correspond to a television channel being stored and/or displayed, the ECM may be provided to smart card 1060 for decryption.

When smart card 1060 receives an encrypted ECM, smart card 1060 may decrypt the ECM to obtain some number of control words. In some embodiments, from each ECM received by smart card 1060, two control words are obtained. In some embodiments, when smart card 1060 receives an ECM, it compares the ECM to the previously received ECM. If the two ECMs match, the second ECM is not decrypted because the same control words would be obtained. In other embodiments, each ECM received by smart card 1060 is decrypted; however, if a second ECM matches a first ECM, the outputted control words will match; thus, effectively, the second ECM does not affect the control words output by smart card 1060. Smart card 1060 may be permanently part of television receiver 1000 or may be configured to be inserted and removed from television receiver 1000.

Tuning management processor 1010-2 may be in communication with tuners 1015 and control processor 1010-1. Tuning management processor 1010-2 may be configured to receive commands from control processor 1010-1. Such commands may indicate when to start/stop recording a television channel and/or when to start/stop causing a television channel to be output to a television. Tuning management processor 1010-2 may control tuners 1015. Tuning management processor 1010-2 may provide commands to tuners 1015 that instruct the tuners which satellite, transponder, and/or frequency to tune to. From tuners 1015, tuning management processor 1010-2 may receive transponder streams of packetized data. As previously detailed, some or all of these packets may include a PID that identifies the content of the packet.

Tuning management processor 1010-2 may be configured to create one or more PID filters 1055 that sort packets received from tuners 1015 based on the PIDs. When a tuner is initially tuned to a particular frequency (e.g., to a particular transponder of a satellite) a PID filter may be created based on a PID of PMT data.

PID filters 1055 may be configured to filter data packets based on PIDs. In some embodiments, PID filters 1055 are created and executed by tuning management processor 1010-2. In other embodiments, separate hardware may be used to create and execute such PID filters. Depending on a television channel selected for recording/viewing, a PID filter may be created to filter the video and audio packets associated with the television channel (based on the PID assignments present in PMT 1057). For example, if a transponder data stream includes multiple television channels, data packets corresponding to a television channel, that is not desired to be stored or displayed by the user, may be ignored by PID filters 1055. As such, only data packets corresponding to the one or more television channels desired to be stored and/or displayed may be filtered and passed to either descrambling engine 1065 or smart card 1060; other data packets may be ignored. For each television channel, a stream of video packets, a stream of audio packets (one or both of the audio programs) and/or a stream of ECM packets may be present, each stream identified by a PID. In some embodiments, a common ECM stream may be used for multiple television channels. Additional data packets corresponding to other information, such as metadata to be stored in metadata 1070, may be appropriately routed by PID filters 1055. At a given time, one or multiple PID filters may be executed by tuning management processor 1010-2.

Descrambling engine 1065 may use the control words output by smart card 1060 in order to descramble video and/or audio corresponding to television channels for storage and/or presentation. Video and/or audio data contained in the transponder data stream received by tuners 1015 may be scrambled. Video and/or audio data may be descrambled by descrambling engine 1065 using a particular control word. Which control word output by smart card 1060 to be used for successful descrambling may be indicated by a scramble control identifier present within the data packet containing the scrambled video or audio. Descrambled video and/or audio may be output by descrambling engine 1065 to storage medium 1025 for storage (in DVR database 1045) and/or to audio/video decoder 1033 for output to a television or other presentation equipment via television interface 1035.

For simplicity, television receiver 1000 of FIG. 10 has been reduced to a block diagram; commonly known parts, such as a power supply, have been omitted. Further, some routing between the various modules of television receiver 1000 has been illustrated. Such illustrations are for exemplary purposes only. The state of two modules not being directly or indirectly connected does not indicate the modules cannot communicate. Rather, connections between modules of the television receiver 1000 are intended only to indicate possible common data routing. It should be understood that the modules of television receiver 1000 may be combined into a fewer number of modules or divided into a greater number of modules. Further, the components of television receiver 1000 may be part of another device, such as built into a television. Also, while television receiver 1000 may be used to receive, store, and present television channels received via a satellite, it should be understood that similar components may be used to receive, store, and present television channels via a cable network.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

1. A method for managing video content navigation, the method comprising:
acquiring, by a video playback device from a remote video management server system, metadata that designates one or more portions of a programming content item as mapped to a plurality of predefined categories;
outputting, by the video playback device, the programming content item for playback;
outputting, by the video playback device, overlaid on the programming content item being output for playback, a scrub bar interface, wherein the scrub bar interface graphically indicates a start point of the programming content, an end point of the programming content, and a scrub bar spanning from the start point to the end point;
outputting, by the video playback device overlaid on the programming content item being output for playback and presented concurrently with the scrub bar interface, a scrub bar navigation interface, wherein:
the scrub bar navigation interface presents the plurality of predefined categories for selection by a user; and
a first predefined category and a second predefined category is selected;
accessing, by the video playback device, the metadata that designates portions of the programming content item as mapped to the first predefined category and the second predefined category; and
outputting, by the video playback device, graphical indications of the first predefined category and the second predefined category as portions directly on the scrub bar based on the metadata and the first predefined category and second predefined category having been selected in the scrub bar navigation interface.

2. The method for managing video content navigation of claim 1, the method further comprising:
receiving, by the video playback device, user input indicating a chapter-based forward jump; and
in response to the chapter-based forward jump, jumping, by the video playback device, playback to a start of a chronologically next portion of the one or more portions of the programming content item that maps to the first predefined category.

3. The method for managing video content navigation of claim 1, the method further comprising:
receiving, by the video playback device, user input indicating a chapter-based backward jump; and
in response to the chapter-based backward jump, jumping, by the video playback device, playback to a start of a chronologically previous portion of the one or more portions of the programming content item that maps to the first predefined category.

4. (canceled)

5. The method for managing video content navigation of claim 1, wherein the scrub bar interface is output without the graphical indications of the first predefined category or the second predefined category immediately prior to the selection of the first predefined category and the second predefined category from the plurality of predefined categories received from the user.

6. The method for managing video content navigation of claim 1, wherein:
the metadata designates different portions of the programming content item as mapped to the first predefined category and the second predefined category selected from the plurality of predefined categories;
multiple graphical indications of the first predefined category and the second predefined category are presented separately on the scrub bar based on the metadata, wherein the multiple graphical indications indicate multiple portions of the programming content item that map to the first predefined category and the second predefined category; and
portions of the programming content item that map to the first predefined category are presented as graphically different on the scrub bar from portions of the programming content item that map to the second predefined category.

7. The method for managing video content navigation of claim 6, the method further comprising:
receiving, by the video playback device, user input indicating selection of the first predefined category for chapter-based jumping functionality, wherein the second predefined category is not selected;
in response to the user input indicating selection of the first predefined category but not the second predefined category, enabling, by the video playback device, chapter-based jumping such that chapter-based jump commands cause jumping between portions of the programming content item that map to the first predefined category, wherein:
the jumping is performed irrespective of portions of the programming content item that map to the second predefined category.

8. The method for managing video content navigation of claim 1, the method further comprising:
receiving, by the video playback device, user input requesting the creation of an abbreviated video sequence file; and
creating, by the video playback device, the abbreviated video sequence file comprising the one or more portions of the programming content item designated by the metadata as mapping to the first predefined category and the second predefined category.

9. The method for managing video content navigation of claim 8, wherein the abbreviated video sequence file is a bookmark file that defines playback of the programming content to include only the one or more portions of the programming content item.

10. The method for managing video content navigation of claim 1, the method further comprising:
collecting, by a video service provider host server system, category determinations from a plurality of video playback devices, wherein the category determinations identify one or more predefined categories from the plurality of predefined categories;
compiling, by the video service provider host server system, the category determinations collected from the plurality of video playback devices; and
creating, by the video service provider host server system, the metadata based on the compiled determinations collected from the plurality of video playback devices.

11. A video playback device that manages video content navigation, the video playback device comprising:
one or more processors; and
a memory communicatively coupled with and readable by the one or more processors and having stored therein processor-readable instructions which, when executed by the one or more processors, cause the one or more processors to:
acquire metadata that designates one or more portions of a programming content item as mapped a plurality of predefined categories;
output for display a scrub bar interface, wherein the scrub bar interface graphically indicates a start point of the programming content, an end point of the programming content, and a scrub bar spanning from the start point to the end point;
output for display a scrub bar navigation interface, wherein:
the scrub bar navigation interface presents the plurality of predefined categories for selection by a user; and
a first predefined category and a second predefined category is selected;
access the metadata that designates portions of the programming content item as mapped to the first predefined category and the second predefined category; and
output graphical indications of the first predefined category and the second predefined category as portions directly on the scrub bar based on the metadata and the first predefined category and the second predefined category having been selected in the scrub bar navigation interface.

12. The video playback device that manages video content navigation of claim 11, wherein the processor-readable instructions, when executed, further cause the one or more processors to:
receive user input indicating a forward skip; and
in response to the forward skip, skip playback to a start of a chronologically next portion of the one or more portions of the programming content item that maps to the first predefined category.

13. The video playback device that manages video content navigation of claim 11, wherein the processor-readable instructions, when executed, further cause the one or more processors to:
receive user input indicating a backward jump; and
in response to the backward jump, jump playback to a start of a chronologically previous portion of the one or more portions of the programming content item that maps to the first predefined category.

14. (canceled)

15. The video playback device that manages video content navigation of claim 11, wherein the scrub bar interface is output without the graphical indications of the first predefined category or the second predefined category immediately prior to the selection of the first predefined category and the second predefined category from the plurality of predefined categories received from the user.

16. The video playback device that manages video content navigation of claim 11, wherein:
the metadata designates different portions of the programming content item as mapped to the first predefined category and the second predefined category selected from the plurality of predefined categories;
multiple graphical indications of the first predefined category and the second predefined category are presented separately on the scrub bar based on the metadata, wherein the multiple graphical indications indicate multiple portions of the programming content item that map to the first predefined category and the second predefined category; and
portions of the programming content item that map to the first predefined category are presented as graphically different on the scrub bar from portions of the programming content item that map to the second predefined category.

17. The video playback device that manages video content navigation of claim 16, wherein the processor-readable instructions, when executed, further cause the one or more processors to:
receive user input indicating selection of the first predefined category for chapter-based jumping functionality, wherein the second predefined category is not selected;
in response to the user input indicating selection of the first predefined category but not the second predefined category, enable chapter-based jumping such that chapter-based jump commands cause jumping between portions of the programming content item that map to the first predefined category, wherein:
the jumping is performed irrespective of portions of the programming content item that map to the second predefined category.

18. The video playback device that manages video content navigation of claim 11, wherein the processor-readable instructions, when executed, further cause the one or more processors to:
receive user input requesting the creation of an abbreviated video sequence file; and
create the abbreviated video sequence file comprising the one or more portions of the programming content item designated by the metadata as mapping to the first predefined category and the second predefined category.

19. The video playback device that manages video content navigation of claim 18, wherein the abbreviated video sequence file is a bookmark file that defines playback of the programming content to include only the one or more portions of the programming content item.

20. A video playback system that manages video content navigation, the video playback system comprising:
a video playback device, comprising:
one or more tuners;
one or more processors; and
a memory communicatively coupled with and readable by the one or more processors and having stored therein processor-readable instructions which, when executed by the one or more processors, cause the one or more processors to:
acquire metadata that designates one or more portions of a programming content item as mapped to a plurality of predefined categories;
output for display a scrub bar interface, wherein the scrub bar interface graphically indicates a start point of the programming content, an end point of the programming content, and a scrub bar spanning from the start point to the end point;
output for display a scrub bar navigation interface, wherein:
the scrub bar navigation interface presents the plurality of predefined categories for selection by a user; and
a first predefined category and a second predefined category is selected;
access the metadata that designates portions of the programming content item as mapped to the first predefined category and the second predefined category; and
output graphical indications of the first predefined category and the second predefined category on the scrub bar based on the metadata and the first predefined category and the second predefined category having been selected in the scrub bar navigation interface; and
a video management server system that stores metadata for a plurality of programming content items including the programming content item and transmits the metadata for the programming content item to the video playback device.
